(19) United States
(12) Patent Application Publication
(10) Pub. No.: US 2008/0035139 A1
(43) Pub. Date: Feb. 14, 2008

(54) Additional bottom adapted to be fixed to the outer surface of the bottom of a vessel

(75) Inventor: Visino Marin, Casalmaggiore (IT)

Correspondence Address: MODIANO & ASSOCIATI, Via Meravigli, 16, Milan, 20123, omitted

(73) Assignee: ATTREZZERIA DI MARIN VISINO & C. S.n.c.

(21) Appl. No.: 11/882,358

(22) Filed: Aug. 1, 2007

(30) Foreign Application Priority Data
Aug. 8, 2006 (IT) MN2006A000054

(51) Int. Cl. A47J 36/00

(52) U.S. Cl. 126/390.1; 220/573.1

(57) ABSTRACT

An additional bottom adapted to be fixed to an outer surface of a bottom of a vessel, provided with holes which are designed to be filled by a material of the vessel during a coining step which fixes the bottom to the vessel, further comprising protrusions which protrude from an outer surface of the bottom of the vessel.

The present invention relates to an additional bottom adapted to be fixed to the outer surface of the bottom of a vessel.

### BACKGROUND OF THE INVENTION

It is known that aluminum alloy vessels for household use, such as pots and pans, designed to be placed in contact with a heat source to cook food, suffer some drawbacks, such as for example the fact that they are unable to cause the automatic activation of the induction plates which are increasingly widespread as heat sources included in household ranges and are notoriously activated by contact with steel elements.

The background art has therefore proposed to add to aluminum alloy vessels, at the outer surface of their bottom, an additional bottom made of steel and provided with holes which are filled by the material of the vessel during a step for coining in an appropriately provided die, thus providing the nonremovable locking of such additional bottom to the bottom of the vessel.

However, flash forms at the rim of the individual holes of the additional bottom and cannot be tolerated in the finished product because it is a source of possible damage to the plates on which the vessels are designed to rest, and therefore it becomes necessary to eliminate such flash by means of a machine-tool process with a consequent considerable cost increase.

The described problem relates not only to aluminum alloy vessels and additional bottoms made of steel, but also when the vessels and the additional bottoms are made of different materials.

### SUMMARY OF THE INVENTION

The aim of the present invention is therefore to provide an additional bottom which can be fixed to the bottom of a vessel without having to provide finishing operations by means of a machine tool.

This aim is achieved by an additional bottom which is adapted to be fixed to the outer surface of the bottom of a vessel, according to the invention, provided with holes which are designed to be filled by the material of the vessel during the coining step which fixes said bottom to said vessel, characterized in that it comprises protrusions which protrude from the outer surface of the bottom of the vessel.

### BRIEF DESCRIPTION OF THE DRAWINGS

Further characteristics and advantages of the present invention will become better apparent from the description of a preferred but not exclusive embodiment thereof, illustrated by way of non-limiting example in the accompanying drawings, wherein:

FIG. 1 is a plan view of the additional bottom according to the invention;

FIG. 2 is a sectional view, taken along the line II-II of FIG. 1;

FIG. 3 is a sectional view of a finished product.

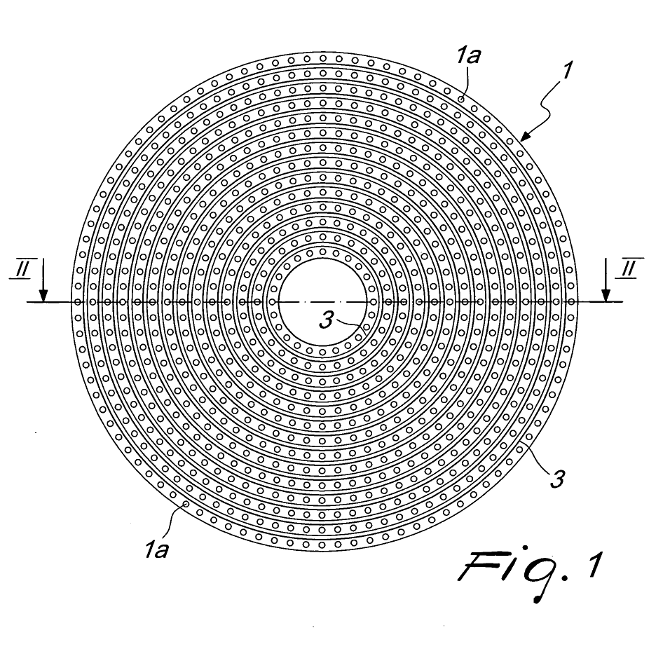

### DESCRIPTION OF THE PREFERRED EMBODIMENTS

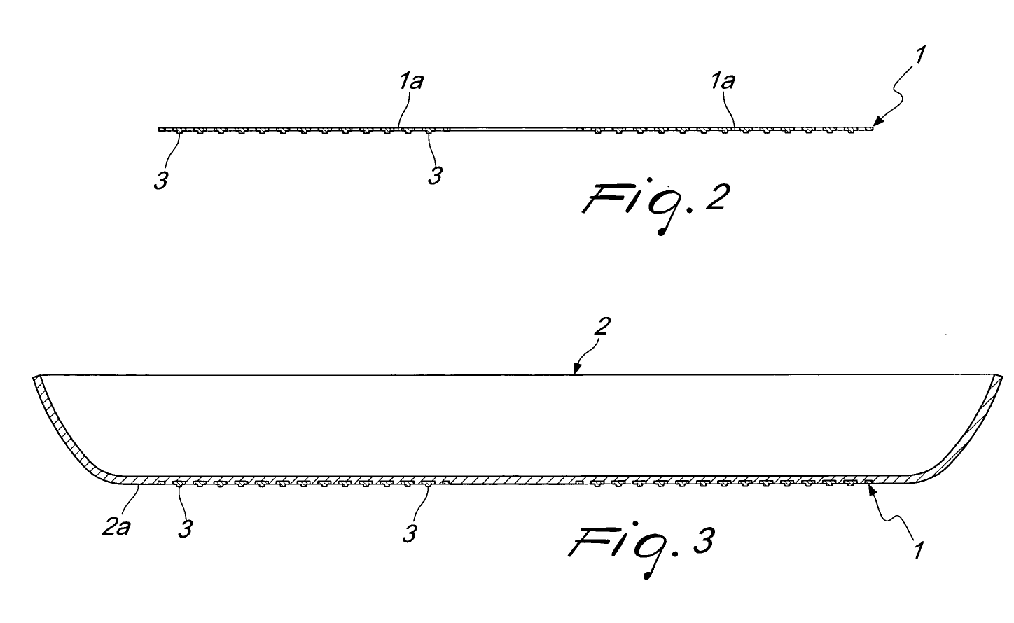

With reference to the figures, the reference numeral 1 generally designates the additional steel bottom provided in a known manner with through holes 1a, which are designed to be filled by the material of an aluminum alloy vessel 2 during the coining step which fixes the additional bottom to the outer surface of the bottom of the vessel, as shown in FIG. 3.

The bottom is flat with a raised edge so as to be fixed to the flat bottom of the vessel.

An important feature of the invention is constituted by the presence of protrusions 3 in the form of concentric circles, which protrude from an outer surface 2a of the bottom of the vessel 2.

In this manner, the resting contact of the vessel 2 on the plates of the ranges occurs at such protrusions and therefore any presence of flash at the rim of the holes 1a is irrelevant, thus removal of the flash is no longer required.

In the illustrated embodiment, it can be seen that the protrusions 3 are obtained as projections from a flat plate, but such protrusions might also be obtained by shaping a sheet having a constant thickness.

The described invention is susceptible of numerous other modifications and variations, all of which are within the scope of the appended claims: thus, for example, the protrusions may have any shape and the additional bottom may lie in contact with at least a portion of the wall of the vessel.

The disclosures in Italian Patent Application No. MN2006A000054 from which this application claims priority are incorporated herein by reference.

What is claimed is:

1. An additional bottom adapted to be fixed to an outer surface of a bottom of a vessel, provided with holes which are designed to be filled by a material of the vessel during a coining step which fixes said bottom to said vessel, further comprising protrusions which protrude from an outer surface of the bottom of the vessel.

2. The additional bottom according to claim 1, having a flat shape so as to be fixed exclusively to the flat bottom of the vessel.

3. The additional bottom according to claim 1, wherein it is flat with a raised edge, so as to be fixed to the flat bottom and at least partially to a wall of a vessel.

4. The additional bottom according to claim 1, wherein said protrusions extend from a flat plate.

5. The additional bottom according to claim 1, wherein the protrusions protrude from a contour of a sheet which has a constant thickness.

6. The additional bottom according to claim 1, wherein the protrusions are shaped like concentric circles.
